(19) United States
(12) Patent Application Publication
(10) Pub. No.: US 2007/0171887 A1
(43) Pub. Date: Jul. 26, 2007

(54) Apparatus, system and method with improved coexistence between multiple wireless communication techniques

(75) Inventor: Shai Waxman, Haifa (IL)

Correspondence Address: INTEL CORPORATION;c/o INTELLEVATE, LLC, P.O. BOX 52050, MINNEAPOLIS, MN, 55402, US

(73) Assignee: Intel Corporation

(21) Appl. No.: 11/340,327

(22) Filed: Jan. 25, 2006

(51) Int. Cl. H04J 3/00

(52) U.S. Cl. 370/345

(57) ABSTRACT

An embodiment of the present invention provides an apparatus, comprising a transceiver capable of passive scanning at least one channel used in a first wireless communication technique and approximating the start time, end time and period of interference caused by signals created from a second wireless communication technique within the channel; and wherein the transceiver is capable of tuning transmission times to be in-between expected time intervals of the interference.

### BACKGROUND

Wireless networks have grown increasingly in importance and have varying uses. Based on how a wireless network will be used, numerous wireless communication techniques have been developed. Examples of wireless communication techniques include, but are not limited to, wireless metropolitan area networks (WMAN) and wireless local area networks (WLAN). Interference may be problematic between various wireless communication signals.

Thus, a strong need exists for techniques to improve coexistence performance for multiple wireless communication techniques.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates interference levels of an 802.16 signal or other TDD signal vs. time and interfering with signals from a wireless local area network (WLAN) access point (AP) or wireless station (STA) of one embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

An algorithm, technique or process is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method.

The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software. as in a cause and effect relationship).

It should be understood that embodiments of the present invention may be used in a variety of applications. Although the present invention is not limited in this respect, the devices disclosed herein may be used in many apparatuses such as in the transmitters and receivers of a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDA's), wireless local area networks (WLAN), personal area networks (PAN, and the like), wireless wide are networks (WWAN) and Mesh networks.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause and effect relationship).

Although it is understood that the present invention is not limited to a particular wireless communication technique, a wireless metropolitan area network (WMAN) licensed exempt (LE) 802.16 station may allocate its band in the unlicensed 2.4/5.8GHz band similarly to wireless local area network (WLAN) and thus potentially interferes with the reception of WLAN signals.

In an embodiment of the present invention, by WLAN AP/STA reliably detecting the 802.16 LE signals & the 802.16 LE frame timing, it can better coordinate its transmission, especially its broadcasting (AP only). By coordinating these transmissions in the time interval between 802.16 LE interferences, the WLAN AP/STA may improve the reception reliability of its WLAN receiving wireless stations (STA)/access points (AP), respectively. The invention can be extended to any long-period TDD interference (802.16 typical periods are 5/10[msec]).

Although the present invention is not limited in this respect, an 802.11 AP/STA that detects a long periodic TDD interference, especially 802.16, not necessarily in its operating band, may find a correlation between the interference and reception reliability and adjust broadcast/delay critical transmission to be in between interference intervals.

An embodiment of the present invention provides for the detection of licensed exempt 802.16 transmissions and its frame timing (DL sub-frame/UL sub-frame) and the coordination of transmissions according to 802.16 frame timing (if 802.11 AP/STA concludes the interference degrades its stations/AP reception performance, respectively, and improvement required).

Detection of 802.16 licensed exempt/long-period TDD transmission:
1. During its passive scanning, the 802.11 AP/STA may use dedicated circuitry (although not required to be, it may use basic RSSI measurement or autocorrelator dedicated for detection of 802.16 signals) to monitor non-802.11 transmissions on the scanned channel. It should be emphasized the scanned channel may be any channel in the 2.4/5.8 GHz band regardless of the current 802.11 AP operating channel.
2. The 802.11 AP/STA approximates the start time, end time & period of the interference.

Coordination of transmission:
1. Although not required, in an embodiment of the present invention, the 802.11 STA/AP may monitor the reception reliability of its AP/stations during the expected interference time period.
2. It may either do that actively (by sending a packet during that time interval and expecting a response) or passively.

Although not required, once the 802.11 AP/STA detects a correlation between at least one of its stations/AP (respectively) reception performance degradation to the expected time interval of interference: a) the 802.11 AP may tune all broadcast (including beacons) transmission times to be in-between expected interference time intervals; and b) the 802.11 AP/STA may tune delay critical transmissions (VolP for example) to be transmitted in-between expected interference time intervals.

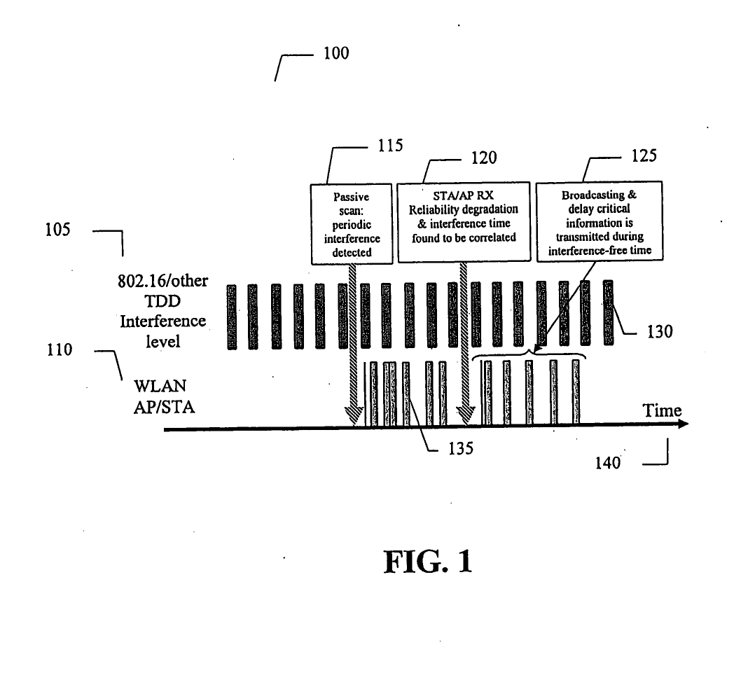

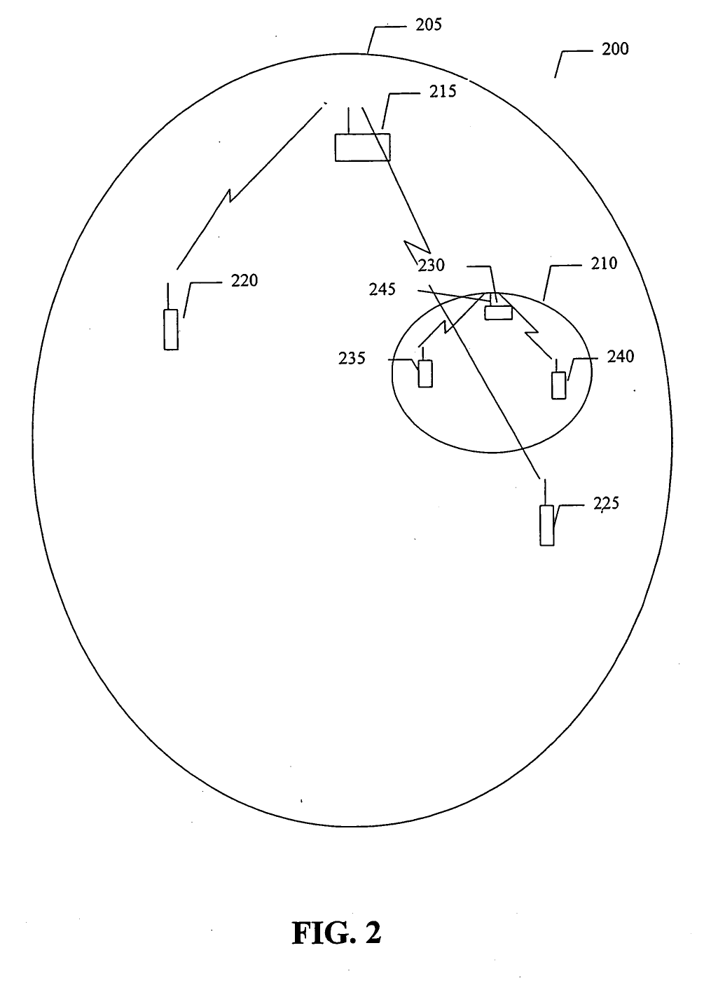

Turning now to FIG. 1, illustrated generally at 100, are interference levels 130 of an 802.16 signal or other TDD signal 105 vs. time 140, interfering with signals 135 from a wireless local area network (WLAN) access point (AP) or wireless station (STA) 110 of one embodiment of the present invention. Passive scan 115 shows periodic interference detected. At 120 the STA/AP RX reliability degradation & interference time may be found to be correlated and thereafter, at 125, broadcasting & delay critical information is transmitted during interference-free time

An embodiment of the present invention further provides a method, comprising passive scanning by a transceiver of at least one channel used in a first wireless communication technique and approximating the start time, end time and period of interference caused by signals created from a second wireless communication technique within the channel; and tuning transmission times to be in-between expected time intervals of the interference. The first wireless communication technique may be set forth in the Institute for Electrical and Electronic Engineers (IEEE) 802.11 standard and the second wireless communication technique may be set forth in the Institute for Electrical and Electronic Engineers (IEEE) 802.16 standard. Further, the transceiver may be an access point (AP) or a wireless station (STA) in a wireless local area network (WLAN) and the interference may be caused by signals generated in a wireless metropolitan area network. In an embodiment of the present invention and not limited in this respect, the present invention may use dedicated circuitry to monitor non-WLAN transmissions and may monitor the reception-reliability during the expected interference time period. The monitoring may be accomplished by actively sending a packet during that time interval and expecting a response and the determining by the transceiver of the existence of interference may be by correlating the transceiver reception performance degradation to the expected time interval of interference.

The present method may further provide tuning by the AP broadcast transmission times to be in-between expected interference time intervals and tuning by the STA delay critical transmissions to be transmitted in-between expected interference time intervals.

In another embodiment of the present invention is provided a machine-accessible medium that provides instructions, which when accessed, cause a machine to perform operations comprising passive scanning by a transceiver of at least one channel used in a first wireless communication technique and approximating the start time, end time and period of interference caused by signals created from a second wireless communication technique within the channel and tuning transmission times to be in-between expected time intervals of the interference.

Turning now to FIG. 2, shown generally at 200, is an embodiment of the present invention which provides a system, comprising an access point 230 operable in a wireless local area network 210, a wireless station 235, 240 operable in the wireless local area network 210 and capable of communicating with the access point 230, and wherein the access point 230 or the wireless station 235, 240 are capable of passive scanning at least one channel within the wireless local area network 210 and approximating the start time, end time and period of interference within the wireless local area network 210 and tuning transmission times to be in-between expected time intervals of the interference.

The access point may include a dipole antenna 245 to facilitate operation in the wireless local area network 210 and the interference may be caused by signals generated in a wireless metropolitan area network 205. Further, the access point 230 may use dedicated circuitry to monitor non-WLAN transmissions. These non-WLAN transmissions may be transmissions from transmitter 215 to wireless stations 220 and 225 in the WMAN 205.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. An apparatus, comprising:
a transceiver capable of passive scanning at least one channel used in a first wireless communication technique and approximating the start time, end time and period of interference caused by signals created from a second wireless communication technique within said channel; and
wherein said transceiver is capable of tuning transmission times to be in-between expected time intervals of said interference.

2. The apparatus of claim 1, wherein said first wireless communication technique is set forth in the Institute for Electrical and Electronic Engineers (IEEE) 802.11 standard.

3. The apparatus of claim 1, wherein said second wireless communication technique is set forth in the Institute for Electrical and Electronic Engineers (IEEE) 802.16 standard.

4. The apparatus of claim 1, wherein said transceiver is an access point (AP) or a wireless station (STA) in a wireless local area network (WLAN).

5. The apparatus of claim 4, wherein said interference is caused by signals generated in a wireless metropolitan area network.

6. The apparatus of claim 4, wherein said access point uses dedicated circuitry to monitor non-WLAN transmissions.

7. The apparatus of claim 1, wherein said transceiver monitors the reception reliability during the expected interference time period.

8. The apparatus of claim 7, wherein said monitoring is accomplished actively by sending a packet during that time interval and expecting a response.

9. The apparatus of claim 1, wherein said transceiver is capable of determining the existence of interference by correlating said transceiver reception performance degradation to the expected time interval of interference.

10. The apparatus of claim 4, wherein said AP tunes broadcast transmission times to be in-between expected interference time intervals.

11. The apparatus of claim 4, wherein said STA tunes delay critical transmissions to be transmitted in-between expected interference time intervals.

12. A method, comprising:
scanning passively by a transceiver of at least one channel used in a first wireless communication technique and approximating the start time, end time and period of interference caused by signals created from a second wireless communication technique within said channel; and
tuning transmission times to be in-between expected time intervals of said interference.

13. The method of claim 12, wherein said first wireless communication technique is set forth in the Institute for Electrical and Electronic Engineers (IEEE) 802.11 standard.

14. The method of claim 12, wherein said second wireless communication technique is set forth in the Institute for Electrical and Electronic Engineers (IEEE) 802.16 standard.

15. The method of claim 12, wherein said transceiver is an access point (AP) or a wireless station (STA) in a wireless local area network (WLAN).

16. The method of claim 15, wherein said interference is caused by signals generated in a wireless metropolitan area network.

17. The method of claim 15, further comprising using dedicated circuitry to monitor non-WLAN transmissions.

18. The method of claim 13, further comprising monitoring by said transceiver the reception reliability during the expected interference time period.

19. The method of claim 18, further comprising monitoring being accomplished by actively sending a packet during that time interval and expecting a response.

20. The method of claim 12, further comprising determining by said transceiver the existence of interference by correlating said transceiver reception performance degradation to the expected time interval of interference.

21. The method of claim 15, further comprising tuning by said AP broadcast transmission times to be in-between expected interference time intervals.

22. The method of claim 15, further comprising tuning by said STA delay critical transmissions to be transmitted in-between expected interference time intervals.

23. A machine-accessible medium that provides instructions, which when accessed, cause a machine to perform operations comprising:
passive scanning by a transceiver of at least one channel used in a first wireless communication technique and approximating the start time, end time and period of interference caused by signals created from a second wireless communication technique within said channel; and
tuning transmission times to be in-between expected time intervals of said interference.

24. The machine-accessible medium of claim 23, further comprising said instructions causing said machine to perform operations further comprising using dedicated circuitry to monitor non-WLAN transmissions.

25. The machine-accessible medium of claim 24, further comprising said instructions causing said machine to perform operations further comprising monitoring by said transceiver the reception reliability during the expected interference time period.

26. The machine-accessible medium of claim 24, further comprising said instructions causing said machine to perform operations further comprising monitoring being accomplished by actively sending a packet during that time interval and expecting a response.

27. The machine-accessible medium of claim 23, further comprising said instructions causing said machine to perform operations further comprising determining by said transceiver the existence of interference by correlating said transceiver reception performance degradation to the expected time interval of interference.

28. A system, comprising:
an access point operable in a wireless local area network capable;
a wireless station operable in said wireless local area network and capable of communicating with said access point; and
wherein said access point or said wireless station are capable of passive scanning at least one channel within said wireless local area network and approximating the start time, end time and period of interference within said wireless local area network and tuning transmission times to be in-between expected time intervals of said interference.

29. The system of claim 28, wherein said access point includes a dipole antenna to facilitate operation in said wireless local area network.

30. The system of claim 28, wherein said interference is caused by signals generated in a wireless metropolitan area network.

31. The system of claim 28, wherein said access point uses dedicated circuitry to monitor non-WLAN transmissions.
